(19) United States
(12) Patent Application Publication
(10) Pub. No.: US 2015/0281920 A1
(43) Pub. Date: Oct. 1, 2015

(54) Processing SMSs to Provide Information to a User

(71) Applicants: Prasad S U M Dhanyamraju, Hyderabad (IN); Satya Sai Prakash Kanakadandi, Hyderabad (IN)

(72) Inventors: Prasad S U M Dhanyamraju, Hyderabad (IN); Satya Sai Prakash Kanakadandi, Hyderabad (IN)

(73) Assignee: HCL TECHNOLOGIES LTD, Chennai (IN)

(21) Appl. No.: 14/670,443

(22) Filed: Mar. 27, 2015

(30) Foreign Application Priority Data
Apr. 1, 2014 (IN) 1731/CHE/2014

(51) Int. Cl. H04W 4/12

(52) U.S. Cl. CPC H04W 4/12

(57) ABSTRACT

Processing SMSs to provide useful, contextual and consolidated (where meaningful) information to a user. The method and user device relate to wireless communication using a user device, and more particularly to the user device processing information present in a SMS (Short Messaging Service) received by a user to present consolidated information to the user. Context of similar messages is derived where user has not specified using text processing techniques.

### TECHNICAL FIELD

The method and user device disclosed herein relate to wireless communication using a user device, and more particularly to processing information present in a SMS (Short Messaging Service) received by a user to present consolidated contextual information to the user.

### BACKGROUND

Currently, users are relying more and more on user devices for their communication purposes. The user devices may communicate using voice calls, messages (SMS (Short Messaging Service), MMS (Multimedia Messaging Service), IM (Instant Messaging) and so on) to track a variety of activities such as financial activities, appointments, due date reminders, travel alerts, ticket status updates, balance alerts/check and so on.

In an example, the transactions performed by a user from a bank account may be updated to the user using SMSs, wherein the user receives an SMS for each transaction, as performed by him. While the user has a means to track each transaction, the user does not have any means to monitor his account balance based on the transactions being done by him in real time, monitor his expenditure in a calendar month and so on.

In another example, consider a user who sets up a meeting with another user, wherein the communication with the other user was done using SMSs including fixing the time and location of the meeting. If the user wants a reminder for the meeting, he has to manually set a reminder for the meeting.

Yet another scenario where a user books his/her ticket in advance (say 45 days before, with a waitlist status) and goes on with routine, at the time of chart preparation final ticket status comes as another SMS. User gets the update alert based on these SMSs about departure time and coach/seat information.

Currently, there are entities that process emails, appointments and other system generated alerts being received by a user for a specific data (such as IP/address of a device, date/time of appointment etc.) and offer a consolidated set of information to the user in the form of SMS or email. However, these entities perform the mining of the data at a back-end server and offer the consolidated specified (preset) information to the user on his user device. Such an approach requires considerable investment from the entity implementing this service (in terms of back-end and communication infrastructure). Also, privacy issues arise as the entity has access to sensitive information of the user (such as financial accounts, account balances, his itinerary/schedule and so on).

### OBJECT

The principal object is to provide a method and a user device for processing information present in an SMS (Short Messaging Service) received by a user locally to present consolidated information to the user.

### SUMMARY

Accordingly the embodiments herein relate to a method for enabling a user device to extract information from a received SMS (Short Messaging Service), the method comprising of parsing the received SMS to extract information by the user device; and performing at least one action related to the information by the user device based on at least one option.

Also, provided herein is a user device for extracting information from a received SMS (Short Messaging Service), the user device further configured for parsing the received SMS to extract information; and performing at least one action related to the information based on at least one option.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This method and user device is illustrated in the accompanying drawings, throughout which like reference letters indicate corresponding parts in the various figures. The embodiments herein will be better understood from the following description with reference to the drawings, in which:

FIG. 1 depicts a communication network configured to send a SMS (Short Messaging Service) to a user device, according to embodiments as disclosed herein;

FIG. 2 depicts a user device, according to embodiments as disclosed herein;

FIG. 3 is a flowchart illustrating the process of a user device scanning a received SMS and performing at least one action based on the received SMS, according to embodiments as disclosed herein; and

FIG. 4 illustrates a computing environment implementing the method for processing information present in a SMS (Short Messaging Service) received by a user to present consolidated information to the user, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

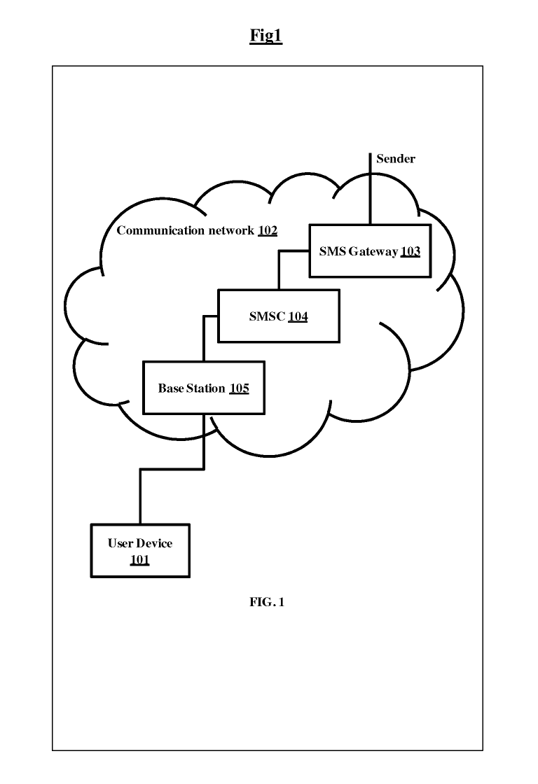

The embodiments herein achieve a method and a system for processing information present in an SMS (Short Messaging Service) received by a user to present consolidated information to the user. Referring now to the drawings, and more particularly to FIGS. 1 through 4, where similar reference characters denote corresponding features consistently throughout the figures, there are shown preferred embodiments.

‘User Device’ herein refers to any device capable of receiving SMSs (Short Messaging Service) and enabling a user of the user device to view the SMS. Examples of the user device are mobile phones, tablets, laptops, personal computers or any other device which may receive SMSs.

FIG. 1 depicts a wireless communication network configured to send an SMS (Short Messaging Service) to a user device, according to embodiments as disclosed herein. The system depicts a communication network 102 connected to at least one user device 101. The communication network 102 may be a network capable of enabling a user of the cellular network 102 to receive SMSs. The user device 101 may be connected to more than one communication network 102. The link between the user device 101 and the communication network 102 may be a wireless communication link.

A sender of an SMS to the user device 101 sends the SMS to the user device 101 through the communication network 102. The communication network 102 routes the SMS to the user device 101, through an SMS gateway 103, an SMS Center (SMSC) 104 and a Base Station (BS) 105.

The user device 101, on receiving the SMS, parses the information present in the SMS and determines the context of the SMS. Based on the identified context, the user device 101 may assign a label to the received SMS. Examples of the label may be banking, credit card, meeting, travel and so on. The user device 101 may use at least one default label. The user device 101 may enable the user to add/delete/modify the labels. The user device 101 extracts information from the SMS and presents the information to the user. The user device 101 may consider at least one condition (wherein the condition may be set by the user or automatically generated), before presenting the information to the user.

The terms ‘SMS gateway’, ‘SMS Center (SMSC)’ and ‘Base Station’ merely serve as an example of the route that an SMS may take through the communication network 102 and does not limit the type of communication network 102 that may be used herein.

In an example, the user device 101, on receiving a SMS, checks the context of the received SMS. If the context of the received SMS relates to the label ‘banking’, the user device 101 checks the bank account details to identify the bank account from where the expense was made. The user device 101 may check this based on a plurality of factors, such as the presence of at least a portion of the bank account number in the SMS, the presence of specific keywords in the SMS (such as debit, debited, transaction and so on) which indicate that money has been debited from the bank account and so on. The plurality of factors may be configured by the user. The plurality of factors may also be determined in an automated manner depending on the context of the SMSs identified by the user device 101, wherein the user may add/delete/modify the factors at any point in time. The user device 101 may extract information from the SMS; such as the amount debited from the account, the date and time of the amount being debited, the details of the merchant involved in the transaction and so on. The user device 101 may maintain a record of the information. The user device 101 may also maintain a total record of the expenditure of the user. The user device 101 may also send an alert to the user on the total being updated. The user may access this information and the total amount, using the user device 101. The user device 101 may also store this information locally in the user device 101 or store the information in another online location. The user device 101 may also raise an alert to the user, based on the proximity of the total to a threshold amount, as set by the user.

In another example, consider the user setting up a meeting with another user using SMSs. The user device 101 checks the SMSs based on at least one keyword/phrase, wherein the keyword/phrase may be ‘see’, ‘meet’, ‘meeting’, ‘appointment’, ‘hotel’, ‘restaurant’, ‘office’, ‘conference’ and so on. The user device 101 may also check for a date, a time, a location and so on. The user device 101 may also check for confirmation words/phrases such as ‘ok’, ‘fine’, ‘see you’ and so on. The at least one of these keywords/phrases may be configured by the user. The at least one of these keywords/phrases, a date and a time may be determined in an automated manner depending on the context of the SMSs identified by the user device 101, wherein the user may modify/add/delete the keywords/phrases at any point in time. The user device 101, on detecting at least one of these keywords/phrases and at least a date and a time in at least one SMS, creates an entry in a calendar, blocking the date, time and location of the meeting. The user device 101 may also enable the user to view, amend the appointment and so on. The user device 101 may also monitor received SMSs to check for any changes/amendments in the meeting schedule. The user device 101 may also enable the meeting details to be updated in an external calendar such as Outlook calendar, Google calendar and so on. The user device 101 may also enable the user to send an invite regarding the meeting to a third party using at least one of an email, SMS and so on.

In another example, consider the user booking an airline ticket. The user on making the booking receives an SMS with the details of the booking, including the flight number, date and time of the flight, PNR (Passenger Number Record) and so on. The user device 101 identifies the context of the SMS as related to an airline travel based on at least one keyword/phrase present in the SMS (such as airline, flight, airport and so on). The user device 101 assigns a label such as ‘travel’ to the SMS. Based on the label, the user device 101 checks the SMSs based on at least one keyword/phrase, wherein the keyword/phrase may be “PNR”, “flight no.” and so on. The user device 101 may also check for a date, a time and so on. The user device 101, on detecting at least one of these keywords/phrases and at least a date and a time in at least one SMS, creates an entry in a calendar, blocking the date, time and location of the flight. The user device 101 may also enable the user to view the flight details. The user device 101 may also monitor received SMSs to check for any changes/amendments in the flight schedule. The user device 101 may also enable the flight details to be updated in an external calendar such as Outlook calendar, Google calendar and so on.

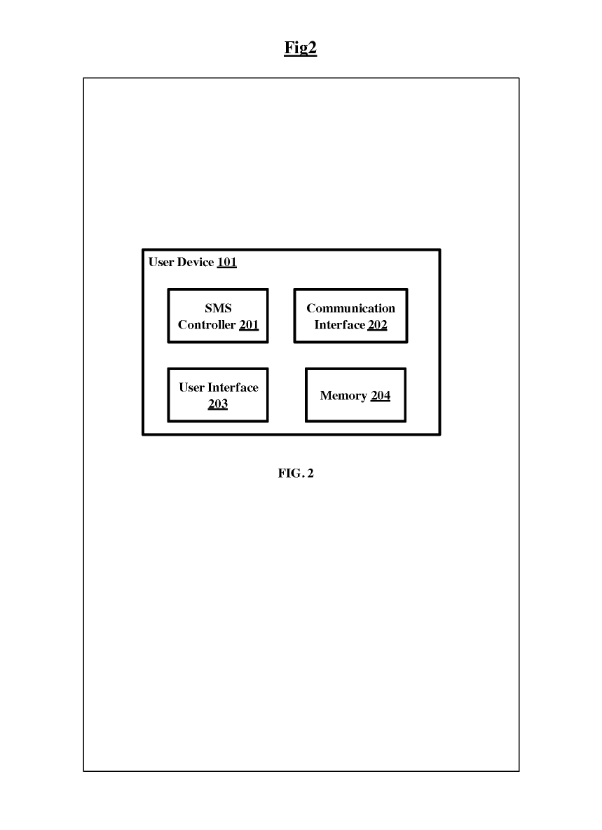

FIG. 2 depicts a user device, according to embodiments as disclosed herein. The user device 101, as depicted, comprises of a SMS controller 201, a communication interface 202, a user interface 203 and a memory 204. The communication interface 202 is configured to enable the user device 101 to send and receive SMSs. The communication interface 202 may also enable the user device 101 to send alerts/information/invites to another user/entity. The user interface 203 may comprise of a display enabling the user of the user device 101 to view, enter and/or amend information. The user interface 203 may also comprise of a speaker and/or microphone to enable a user to interact with the user device 101. The memory 204 may be used to store data. The memory 204 may comprise of at least one of volatile memory and/or non-volatile memory.

The user interface 203 may comprise of at least one display, a speaker and so on. The user interface 203 may enable the user to configure options. The user may set up the data to be monitored (contexts), such as bank accounts, meetings, credit cards, travel plans and so on. Examples of the options may be a limit for monthly expenses from a bank account, a limit for monthly expenses for monthly expenses from his credit card, a limit for monthly expenses from all his accounts, alerts for meetings, alerts for journeys and so on. The user interface 203 may also enable the user to add/delete/modify keywords/phrases, which the user device may check in the SMSs. The options as set by the user may be stored in the memory 204.

The SMS controller 202 may determine the data to be monitored and contexts in an automatic manner, such as bank accounts, meetings, credit cards, travel plans and so on. Examples of the options may be a limit for monthly expenses from a bank account, a limit for monthly expenses for monthly expenses from his credit card, a limit for monthly expenses from all his accounts, alerts for meetings, alerts for journeys and so on. The SMS controller 202 may populate keywords/phrases to be checked in the SMSs, wherein the user interface 203 may enable the user to add/delete/modify keywords/phrases and contexts, which the user device may check in the SMSs.

The SMS controller 202 may monitor SMSs received by the user device 101, through the communication interface 202. On receiving a SMS, the SMS controller 202 may check for the context to which the received SMS belongs. Based on an identified context, the SMS controller 202 assigns a label to the SMS. For example, if the SMS is from a credit card company intimating a financial transaction on the card, the SMS controller 202 may assign a label as ‘banking’. In another example, if the SMS is from a travel agency with the details of a flight, the SMS controller 202 may assign a label as ‘travel’. The SMS controller 202 may automatically determine the label. The user may add/delete/modify the labels. Further, the SMS controller 202 checks for at least one keyword/phrase in the received SMSs. The SMS controller 202 may check based on at least one of the options, as set by the user. The SMS controller 202 may check based on a pre-determined set of options, wherein the user may add/delete/modify the pre-determined set of options. The SMS controller 202 may check based on the identified context, wherein each context may have a pre-determined set of options associated with it. If the SMS matches at least one option, the SMS controller 202 parses the SMS and extracts information from the SMS. The SMS controller 202 may further perform at least one action related to the information extracted from the SMS. The action may comprise of creating a meeting entry in a calendar, adding to his monthly expenses and so on. The SMS controller 202 may also enable the user to access the results of the action, using the user interface 203.

The user interface 203 may enable the user to access the result of the action, wherein the access may be in the form of receiving alerts, viewing information and so on, wherein the user may access the result of the action in the form of at least one of or a combination of audio, visual, audiovisual and text.

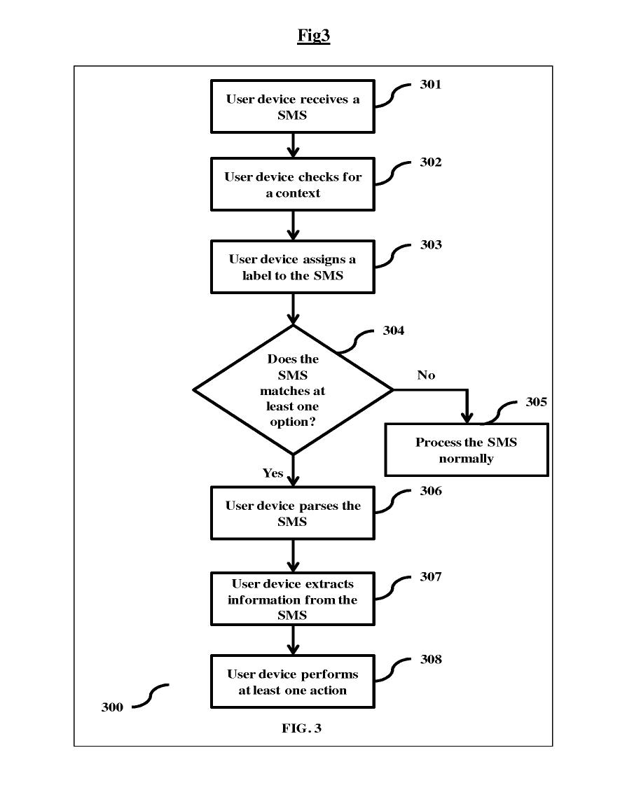

FIG. 3 is a flowchart illustrating the process of a user device scanning a received SMS and performing at least one action based on the received SMS, according to embodiments as disclosed herein. On receiving (301) a SMS, the user device 101 checks (302) for the context of the SMS. Based on the context, the user device 101 assigns (303) a label to the SMS. Based on the context and the label, the user device checks (304) for at least one keyword/phrase in the received SMSs. If the SMS does not match at least one option, the user device 101 treats (305) the SMS as a normal SMS. If the SMS matches at least one option, as set by the user, the user device 101 parses (306) the SMS and extracts (307) information from the SMS. The SMS controller 202 further performs (308) at least one action related to the information extracted from the SMS. The action may comprise of creating a meeting entry in a calendar, adding to his monthly expenses and so on. The various actions in method 300 may be performed in the order presented, in a different order or simultaneously. Further, in some embodiments, some actions listed in FIG. 3 may be omitted.

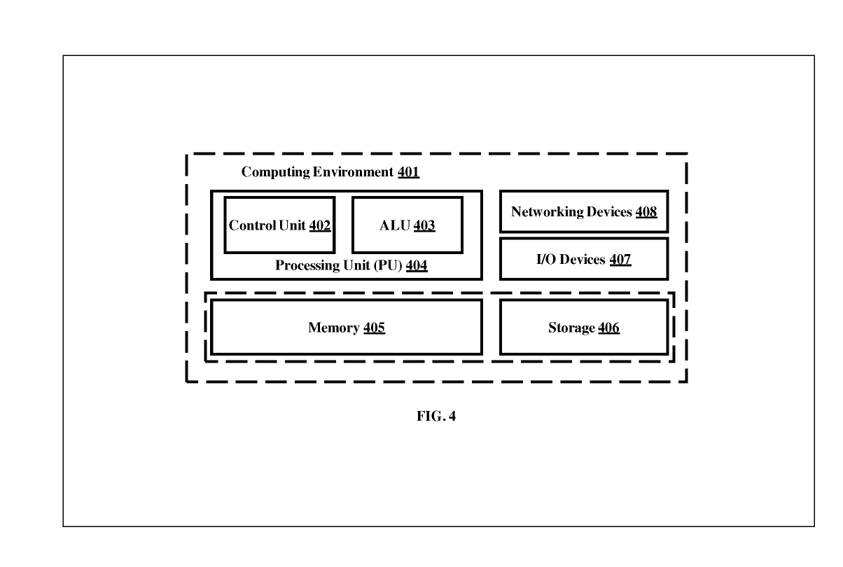

FIG. 4 illustrates a computing environment implementing the method for processing information present in a SMS (Short Messaging Service) received by a user to present consolidated information to the user, according to embodiments as disclosed herein. As depicted the computing environment 401 comprises at least one processing unit 404 that is equipped with a control unit 402 and an Arithmetic Logic Unit (ALU) 403, a memory 405, a storage unit 406, plurality of networking devices 40XX and a plurality Input output (I/O) devices 407. The processing unit 404 is responsible for processing the instructions of the algorithm. The processing unit 404 receives commands from the control unit in order to perform its processing. Further, any logical and arithmetic operations involved in the execution of the instructions are computed with the help of the ALU 403.

The overall computing environment 401 can be composed of multiple homogeneous and/or heterogeneous cores, multiple CPUs of different kinds, special media and other accelerators. The processing unit 404 is responsible for processing the instructions of the algorithm. Further, the plurality of processing units 404 may be located on a single chip or over multiple chips.

The algorithm comprising of instructions and codes required for the implementation are stored in either the memory unit 405 or the storage 406 or both. At the time of execution, the instructions may be fetched from the corresponding memory 405 and/or storage 406, and executed by the processing unit 404.

In case of any hardware implementations various networking devices 408 or external I/O devices 407 may be connected to the computing environment to support the implementation through the networking unit and the I/O device unit.

The embodiments disclosed herein can be implemented through at least one software program running on at least one hardware device and performing network management functions to control the network elements. The network elements shown in FIGS. 1 and 2 include blocks which can be at least one of a hardware device, or a combination of hardware device and software module.

The embodiment disclosed herein describes a method for processing information present in a SMS (Short Messaging Service) received by a user to present consolidated information to the user, according to embodiments as disclosed herein. Therefore, it is understood that the scope of the protection is extended to such a program and in addition to a computer readable means having a message therein, such computer readable storage means contain program code means for implementation of one or more steps of the method, when the program runs on a server or user device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the user device disclosed herein may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A method for enabling a user device to extract information from a received SMS (Short Messaging Service), the method comprising of
parsing the received SMS to extract information by the user device; and
performing at least one action related to the information by the user device based on at least one option.

2. The method, as claimed in claim 1, wherein the method further comprises of identifying a context for the received SMS by the user device;
assigning a label to the received SMS by the user device based on the identified context; and
parsing the received SMS to extract information by the user device based on the identified context and the label.

3. The method, as claimed in claim 1, wherein the method further comprises of access a result of the at least one action by a user of the user device using a user interface in the user device.

4. A user device for extracting information from a received SMS (Short Messaging Service), the user device further configured for
parsing the received SMS to extract information; and
performing at least one action related to the information based on at least one option.

5. The user device, as claimed in claim 4, wherein the user device is further configured for
identifying a context for the received SMS;
assigning a label to the received SMS based on the identified context; and
parsing the received SMS to extract information based on the identified context and the label.

6. The user device, as claimed in claim 4, wherein the user device is further configured for enabling a user of the user device to access a result of the at least one action using a user interface in the user device.
